(19) United States
(12) Patent Application Publication
(10) Pub. No.: US 2002/0053963 A1
(43) Pub. Date: May 9, 2002

(54) Power circuit breaker with an actuating shaft

(76) Inventors: Jorg-Uwe Dahl, Werder (DE); Ludvik Godesa, Berlin (DE); Marc Liebetruth, Glienicke (DE)

Correspondence Address: KENYON & KENYON, ONE BROADWAY, NEW YORK, NY, 10004, US

(21) Appl. No.: 09/508,021

(22) PCT Filed: Sep. 4, 1998
(86) PCT No.: PCT/DE98/02693

(30) Foreign Application Priority Data
Sep. 4, 1997 (DE) 197 39 702.6

(51) Int. Cl. H01H 75/00; H01H 77/00

(52) U.S. Cl. 335/202

(57) ABSTRACT

A low-voltage circuit breaker has a contact arrangement (19), a drive mechanism (20) for actuating the contact arrangement (19), and an actuating shaft (2), which is used for transmitting a drive force from the drive mechanism (20) to the contact arrangement (19). A bearing device for the actuating shaft (2) has at least one bearing body (1), which is connected to a pole component (4) accommodating the contact arrangement (19). Thus a unit is formed, which can be tested independently of the other components of the circuit breaker. In the case of multipole circuit breakers, a common actuating shaft (2) is used for all contact arrangements (19) and pole components (4), which is mounted approximately in the center of the main bearing body (1) and near the ends of the auxiliary bearing bodies (8, 9).

The present invention relates to a low voltage circuit breaker having a contact arrangement, a drive mechanism for actuating the contact arrangement, and an actuating shaft for transmitting a drive force from the drive mechanism to the contact arrangement, and a bearing arrangement accommodating the actuating shaft.

Low voltage circuit breakers have a plurality of components that are adapted to different partial functions and are connected to one another during the manufacture of the circuit breaker. The largest components or units are the switching poles, i.e., contact systems that include stationary and movable switching contacts, with their support insulation and components for connecting to a drive mechanism common to a plurality of such switching poles. The movement provided by the drive mechanism is transmitted to all existing contact systems via an actuating shaft supported at a fixed point. Formerly the actuating shaft was considered as a component of the drive mechanism from the design point of view.

An example of this design is shown in German Patent 44 16 088, which presents a lever arrangement having a conventional design for transmitting a drive force. It has parallel support plates and limiting parts attached thereto, which reduce the distance between the support plates to an appropriate value for guiding the articulated levers. The hinge pins of the levers are slidingly guided on the limiting parts.

German Patent Specification 44 16 090 shows a bearing arrangement for an actuating shaft of a multipole electrical switchgear having a bearing mechanism formed by parallel walls and having shaft bearings with half-shells. In German Offenlegungsschrift 42 27 352 there is illustrated an actuating shaft common to the pole units formed from the switching chambers, which is formed from shaft segments corresponding to the pole units. The pole units rest on a support, which is dimensioned according to the largest width of the pole units. Further illustrations of force transmission systems for actuating switching contacts are described in German Patent Specification 28 35 879 and German Offenlegungsschrift 27 26 489. All these described designs have proven to facilitate the manufacture of the individual components, but they have the disadvantage that their function cannot be tested until the circuit breaker is fully assembled.

This means that, from the mechanical point of view, if a defect is found in a fully assembled circuit breaker, it is difficult to determine which component is defective. Ultimately the fully assembled components must be disassembled in order to replace the defective component.

The object of the present invention is therefore to facilitate testing and reduce the time needed for troubleshooting. In particular, a test of whether the path provided by the drive yields the contact force needed for regular closing of the contact arrangements is to be performed.

This object is achieved according to the present invention by the fact that the bearing arrangement for the actuating shaft has at least one bearing body connected to a pole component accommodating the contact arrangement.

The “switching pole” component thus becomes fully operational by itself and can be tested in a simple manner before the circuit breaker is fully assembled. Furthermore, there are no disadvantages to the standalone testability of the drive mechanism.

According to a preferred embodiment of the present invention, the actuating shaft is integrated in the “switching pole” component by using at least three bearing bodies, the central main bearing body having essentially known elements, in particular springs for providing a retaining force, end stops, a chatter limiter and elements for absorbing residual energy. This central main bearing body is advantageously connected to one wall of the pole component via a combination of positive and non-positive attachment elements. These may advantageously be two or more plug-in bases in conjunction with the respective pocket holes in the wall of the pole component, and centering journals with internal threads that align the central main bearing body with respect to the pole component wall and the drive mechanism. Near its ends the actuating shaft is supported by two auxiliary bearing bodies, which are preferably fastened in the same manner or in similar manners, but which have only part or none of the above-mentioned additional functions. The manufacture and assembly of the actuating shaft can be facilitated by dividing the actuating shaft into two symmetric segments. These segments are driven synchronously via a coupling pin traversing the lever mounted on both segments of the actuating shaft. The advantage of the two-part actuating shaft is that each of the segments is supported at two bearing points. The type of support is thus statically determined and can therefore be implemented with little play. Any possible alignment error is compensated via the coupling without affecting the friction characteristics.

The main bearing body is provided with an abutment for retaining springs, which is preferably molded onto the main bearing body to form a single piece. The retaining springs can be mounted on the main bearing body prior to the assembly of the bearing arrangement. The retaining springs are thus arranged in a compact manner and advantageously engage the actuating shaft lever as a dead center or super-dead center system. This reduces the reaction on the main energy storage device of the switching drive.

The invention is now elucidated in detail with reference to the preferred embodiment illustrated in the figures.

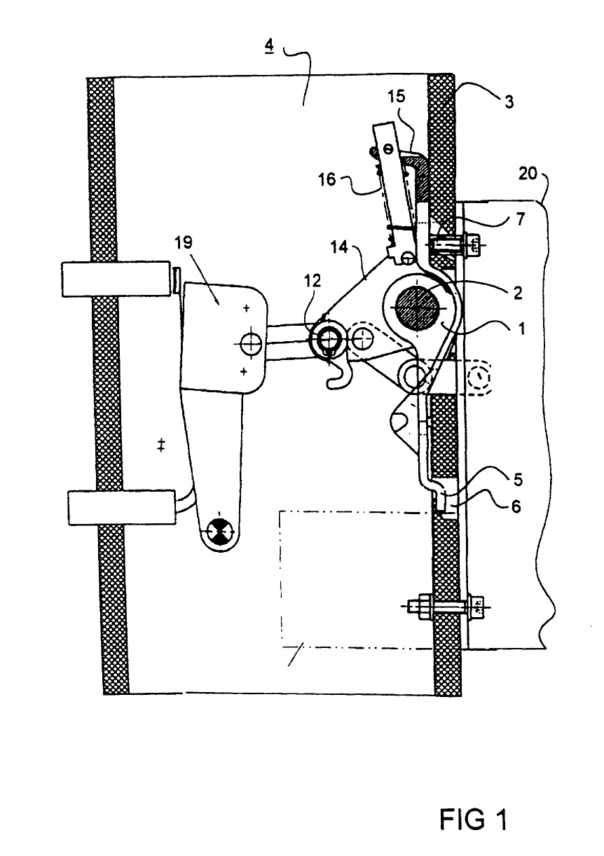

FIG. 1 schematically shows the lateral view of the arrangement of the actuating shaft in the “switching pole” component with the contact arrangement closed;

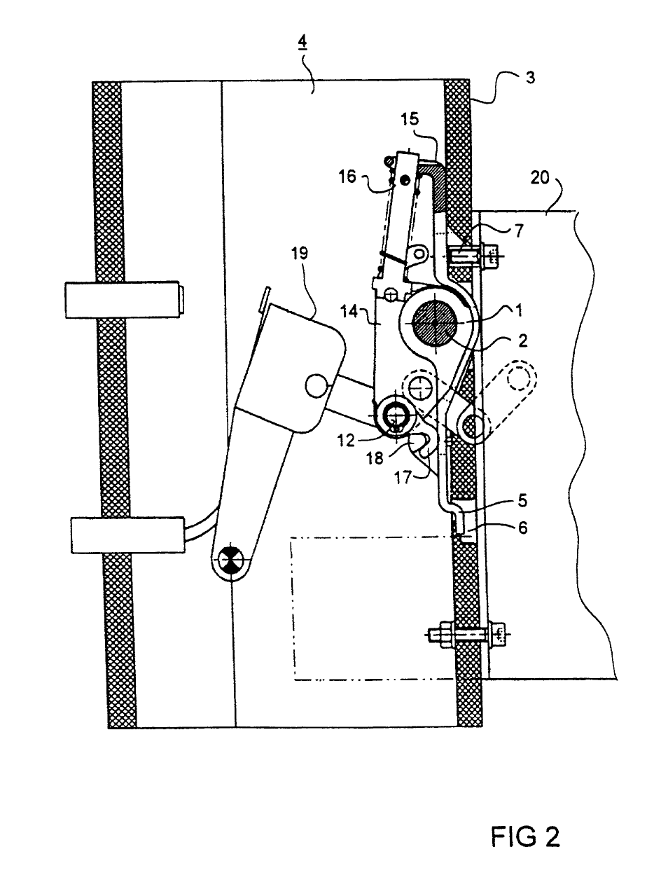

FIG. 2 schematically shows the arrangement according to FIG. 1 with the contact arrangement open.

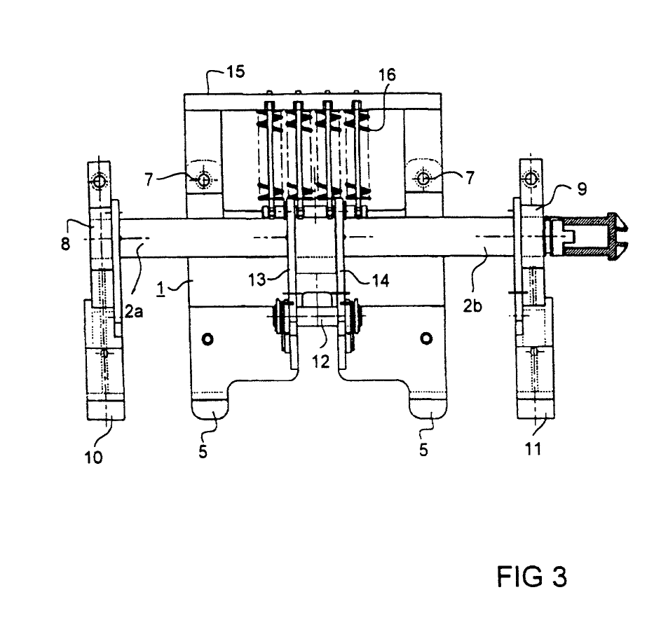

FIG. 3 schematically shows a front view of the arrangement according to FIG. 1.

FIGS. 1 and 2 show the arrangement of central main bearing body 1 with actuating shaft 2. This central main bearing body 1 is connected by two plug-in bases 5 in conjunction with corresponding pocket holes 6 to a wall 3 of pole component 4 and centering journal 7 having an internal thread, which align main bearing body 1 with respect to wall 3 of pole component 4 and with respect to drive mechanism 20 that is only indicated in FIG. 1. As FIG. 3 shows, actuating shaft 2 is supported near its ends by two auxiliary bearing bodies 8 and 9, which are also secured via plug-in bases 10 and 11.

As FIG. 3 shows in more detail, actuating shaft 2 is designed in the form of two symmetrical segments 2a and 2b, which are provided with levers 13 and 14 on their coupling sides; levers 13 and 14 are connected with one another via coupling pin 12, which traverses these two levers 13 and 14 mounted on the two segments 2a and 2b of actuating shaft 2. Main bearing body 1 is provided with an abutment 15 for retaining springs 16, which is molded on main bearing body 1 to form a single piece. Pivoting hooks 17 are arranged on levers 13 and 14 via coupling pins 12 and hook onto catch elements 18 during the circuit breaker opening motion, thus preventing contact arrangement 19 from chattering. The above-described arrangement of an actuating shaft 2 is well suited, in particular, for multipole circuit breakers, where pole components 4, as FIGS. 1 and 2 show, are arranged next to one another and are actuated jointly by actuating shaft 2. Instead of single-pole components, a contiguous three-, four-, or multipole pole component can also be provided. The advantages of the invention are that the joint operation of the drive, actuating shaft and circuit breaker pole can be tested prior to the final assembly of the circuit breaker. If a defect is found, the components of the final assembly do not need to be dismantled in order to replace the defective components. Thus the time required for troubleshooting is considerably reduced. This is particularly advantageous in the case of multipole circuit breakers.

1. A low-voltage circuit breaker having a contact arrangement (19), a drive mechanism (20) for actuating the contact arrangement (19), and an actuating shaft (2) for transmitting a drive force from the drive mechanism (20) to the contact arrangement (19) and a bearing arrangement that accommodates the actuating shaft (2),
characterized in that the bearing arrangement for the actuating shaft (2) has at least one bearing body (1) connected to the pole component (4), which accommodates the contact arrangement (19).

2. The low-voltage circuit breaker according to claim 1, characterized in that the bearing arrangement includes at least three bearing bodies connected in a positive and non-positive manner to a wall (3) of the pole component (4), including one centrally located main bearing body (1), which has essentially known additional elements (16, 17, 18), and two auxiliary bearing bodies (8, 9) next to the ends of the actuating shaft (2) which have no or not all the additional elements of the main bearing body (1).

3. The low-voltage circuit breaker according to claim 2, characterized in that the main bearing body (1) has two or more plug-in bases (5) for connection to the corresponding pocket holes (6) in the wall (3) of the pole component (4) and centering journals (7) for aligning the main bearing body (1).

4. The low-voltage circuit breaker according to claim 2, characterized in that each of the auxiliary bearing bodies (8, 9) has one or more plug-in bases (10, 11) for connection to the corresponding pocket holes (6) in the wall (3) of the pole component (4) and centering journals (7) for aligning the auxiliary bearing bodies (8, 9).

5. The low-voltage circuit breaker according to one of claims 2 through 4,
characterized in that the centering journals (7) are provided with internal threads.

6. The low-voltage circuit breaker according to claim 2, characterized in that the essentially known additional elements (16, 17, 18) are end stops, a chatter limiter (17, 18), devices for absorbing residual energy and retaining springs (16).

7. The low-voltage circuit breaker according to one of claims 2 through 6,
characterized in that a centrally located main bearing body (1) has an abutment (15) for the retaining springs (16) acting in the manner of a dead center or a superdead center.

8. The low-voltage circuit breaker according to claim 7, characterized in that the abutment (15) is molded on the main bearing body (1) to form a single piece.

9. The low-voltage circuit breaker according to one of claims 1 through 8,
characterized in that the actuating shaft (2) is made of two segments (2a, 2b), which are provided with levers (13, 14) at their coupling sides.

10. The low-voltage circuit breaker according to claim 9, characterized in that the segments (2a, 2b) of the actuating shaft (2) have a symmetric design.

11. The low-voltage circuit breaker according to claims 9 and 10,
characterized in that the segments (2a, 2b) of the actuating shaft (2) are connected to one another to ensure synchronized actuation.

12. The low-voltage circuit breaker according to claims 9 through 11,
characterized in that a coupling pin (12) traversing the levers (13, 14) on the segments (2a, 2b) of the actuating shaft (2) is provided for connecting the segments (2a, 2b) of the shaft (2).
